(19) United States
(12) Patent Application Publication
(10) Pub. No.: US 2026/0179356 A1
(43) Pub. Date: Jun. 25, 2026

(54) "Action to Intent" AI Workflow for Translating Multimedia Edits into Multimodal Intent Explanations

(71) Applicants: Uma Kelkar, San Jose, CA (US); Gabriel Gabra Zaccak, Palo Alto, CA (US)

(72) Inventors: Uma Kelkar, San Jose, CA (US); Gabriel Gabra Zaccak, Palo Alto, CA (US)

(21) Appl. No.: 19/432,153

(22) Filed: Dec. 24, 2025

Related U.S. Application Data
(60) Provisional application No. 63/738,720, filed on Dec. 24, 2024.

(51) Int. Cl. G06V 10/74; G06F 40/30

(52) U.S. Cl. CPC G06V 10/761; G06F 40/30

(57) ABSTRACT

A method and system for translating visual edits into personalized textual intent statements. The system extracts visual feature vectors characterizing design elements from unedited and edited digital assets, allows user correction of detected features to build personalized visual vocabularies, and generates joint multimodal representations stored as vector embeddings in a graph database. By maintaining comprehensive edit history, performing similarity-based retrieval of user-specific examples, and employing a multimodal large language model, the system generates intent statements that map manipulated design elements to intended design principles. This bridges communication between visually-oriented creators and non-visually-oriented audiences, reducing the burden of textual explanation for visual thinkers while improving communication quality in creative, educational, and professional workflows.

### CROSS-REFERENCE TO RELATED APPLICATIONS

This application claims the benefit of U.S. Provisional Application No. 63/738,720, filed Dec. 24, 2024, which is hereby incorporated by reference in its entirety.

### FIELD OF THE INVENTION

The present invention relates generally to artificial intelligence (AI) systems for interpreting user markup edits, visual annotations, and design modifications, and providing explanatory rationales. More specifically, it concerns a workflow—referred to as “Action to Intent”—that extracts visual feature vectors from user edits, generates joint multimodal representations combining visual and textual data, tracks and maintains the history of user edits in a graph database, and uses a multimodal large language model (LLM) with user-specific few-shot examples to generate personalized “intent statements” that translate visual editing actions into natural language explanations. These statements are tailored based on the user's previous knowledge, style, and editing patterns, facilitating improved communication among peers, instructors, and students, particularly bridging communication between visually-oriented creators and non-visually-oriented audiences.

### BACKGROUND OF THE INVENTION

In various educational, creative, or professional environments, edits (e.g., modifications to text, designs, images) are tracked but rarely explained. Traditional tracking tools show what changed (e.g., “Track Changes” in word processors, version history in collaborative design applications), but they do not clarify why the edit was made.

In online educational contexts, students often fail to receive actionable feedback. Without teacher feedback, student success rates are low.

In creative and design collaborations, multiple designers make iterative changes (such as cropping, flipping, coloring). Without a clear explanation, peers or clients may be confused about the final outcome's intent, leading to reduced buy-in, additional design iterations, bloated budgets, and stretched timelines.

A fundamental challenge exists in creative and design fields: visually-oriented professionals think and communicate most naturally through visual means, yet they are often required to use text-based tools to explain their work. Text is an inherently lossy medium for conveying visual intent. When expert visual designers must communicate with non-expert clients, customers, or students, writing textual explanations is exhausting and often fails to capture the full meaning of visual decisions.

Furthermore, in design and visual arts, there exists a fundamental distinction between what users can directly manipulate and what they are ultimately trying to achieve. Users can only directly change elements of design—line, shape, color, size, direction, texture, and value. However, users are typically reacting to and attempting to achieve principles of design—gradation, repetition, contrast, harmony, dominance, unity, and balance. Existing tools do not bridge this gap between the elements users manipulate and the principles they intend to express.

These scenarios highlight a need for an AI-driven solution that captures the entire history of user edits, extracts meaningful visual features, and translates visual editing actions into human-readable, context-aware “intent statements.” Importantly, different users or teachers often have unique styles or teaching philosophies. A personalized approach ensures that each user's or teacher's examples inform the AI's output—thus making the feedback more accurate and user-specific.

### SUMMARY OF THE INVENTION

The present invention provides an “Action to Intent” system comprising the following core components:
Visual Feature Extraction Module: The system automatically extracts visual feature vectors from unedited and edited digital assets. These feature vectors characterize design elements including line quality, shape composition, color properties, color harmony, color distribution, edge width variation, gradients, composition of shapes in size and values, distribution of values, perspective, depth separation, and distortion. The extracted features correspond to the fundamental elements of design that users directly manipulate: line, shape, color, size, direction, texture, and value.

User-Correctable Feature Detection: After automatic extraction, the system presents the detected visual features to the user. The user may correct or refine the feature detection, and the system records these corrections. This process creates a personalized visual vocabulary for each user, establishing what specific visual features mean to that individual user. Over time, this builds a personalized “recipe” that captures the user's unique interpretation of visual elements.

Joint Multimodal Representation (Multimodal Vector Embedding): The system generates joint representations that combine the extracted visual feature vectors with textual metadata, user annotations (including marks, drawings, and text that the user places on the image), and edit parameters. These joint multimodal representations are stored as vector embeddings, enabling semantic similarity retrieval that considers both visual and textual aspects of edits.

Graph Database Storage: The system stores edit history, visual features, user profiles, and their interrelationships in a graph database. The graph structure captures relationships between edits made by users, the visual features associated with those edits, and the users themselves. This enables traversal-based retrieval of contextually related examples and supports the discovery of patterns across a user's editing history.

Input and Output Modules: These modules capture both the original and final states of the content (image, text, design, etc.). For images, this might mean storing both the untouched original file and the edited final file; for text documents, it might be a “before” and “after” version.

Action History Logging: All edits (e.g., crop, flip, flipY, rotation, custom AI workflows, text annotations, rewriting a paragraph, shape and arrow additions, marking an area of interest) are recorded along with their associated visual feature vectors and joint multimodal representations. In one embodiment, the system uses JSON objects to store the actions. However, any structured format (XML, SQL tables, NoSQL documents, etc.) may be used in conjunction with the graph database to capture and manage the edit history. Crucially, the system owns or controls this history, ensuring it can feed all relevant data to the AI.

Dynamically Selected User-Specific Few-Shot Examples: Instead of requiring users to explicitly provide example edits paired with rationales, the system automatically selects relevant examples from the user's accumulated edit history by performing similarity retrieval on the vector embeddings. The system performs dynamic example selection by identifying and retrieving examples most relevant to the current task or context from the comprehensive edit history. Contextual matching selects examples based on factors such as similar visual features, similar design elements manipulated, content types, user roles, or objectives (e.g., improving color harmony, enhancing composition). Through implicit style modeling, the system builds a nuanced understanding of each user's personal editing style and rationale over time, without requiring explicit input from the user.

Goal-Driven Semantic Capture: The system captures entire reasoning arcs from design intent through execution to output. By tracking not just individual edits but the goal-directed sequences of edits, the system builds semantically meaningful representations that encode the purpose behind editing workflows, not merely the mechanical changes made. This goal-driven approach enables the system to understand and articulate the higher-level objectives that motivated a series of edits.

Multimodal LLM Analysis: A multimodal large language model receives the combined input comprising the current edit actions, the joint multimodal representation including visual feature vectors, the history of prior edits, and the few-shot examples describing the user's previous editing rationale. The multimodal nature of the model is essential because the system must interpret visual editing actions that cannot be fully expressed in text alone. The LLM then infers the reasoning behind each edit—mapping from the design elements the user changed (line, focal plane, shape, color, size, direction, texture, value) to the design principles the user intended to achieve (gradation, repetition, contrast, harmony, dominance, unity, balance).

Intent Extraction and Explanation Generation: Using domain knowledge of design principles and elements, plus the user's personal examples and corrected feature interpretations, the LLM crafts a concise, plain-language “intent statement.” The system translates visual editing decisions into textual explanations, bridging communication between visually-oriented users who created the edit and non-visually-oriented recipients (such as clients, customers, or students) who receive the explanation. Examples include: “Cropped image to focus the viewer's attention on the subject, creating greater visual dominance” (Image Editing); “Adjusted color saturation to improve harmony between foreground and background elements” (Design); “Added a weekly goal section to enhance task organization and focus” (Bullet Journaling).

Feedback Loop and Continuous Improvement: The system stores generated intent statements in association with their corresponding edits and joint multimodal representations. These stored associations become available as few-shot examples for future edits, creating a self-improving feedback loop. Over time, the system builds a growing library of action-to-intent pairs that enables progressively more accurate intent statement generation as the user's edit history accumulates.

Personalized Output: The system displays the generated explanation in the user interface or saves it in a revision history. Because it leverages the user's unique examples and personalized visual vocabulary built through feature correction, each explanation is personalized and consistent with that individual's approach.

One of the inventive steps is that the system cannot effectively produce an intent statement without a comprehensive record of changes and their associated multimodal representations. By owning and controlling the edit history, visual feature data, and graph relationships, the invention builds a growing library of action-to-intent feedback pairs, providing rich context that allows the AI to continually improve and refine its ability to articulate the reasoning behind edits.

The invention is designed to operate across multiple domains, including but not limited to image editing, text editing, video editing, audio editing, and document organization, particularly in domains where visual or multimodal content is edited and where communication of design intent to non-expert audiences is valuable. While JSON is highlighted for illustrative clarity, the system supports any structured format—such as XML, SQL tables, or NoSQL documents—for storing and querying edit histories, with the graph database providing relational structure across these data stores.

### BRIEF DESCRIPTION OF THE DRAWINGS

FIG. 1 is an original image uploaded to the system for processing, illustrating a watercolor painting of an urban street scene with a tram.

FIGS. 2A-2B illustrate two embodiments of user input to the system. FIG. 2A is a screenshot showing the user text interface of the system, including a text input field with the prompt “Blur the left building” and the uploaded image displayed below, demonstrating text-based commands for generative AI edits. FIG. 2B is a screenshot showing a visual annotation embodiment, wherein the user has drawn a circled region over the tram on the image and provided a separate text comment from an expert user (Pedro) stating “Enlarging the tram makes it more prominent as does blurring the background,” demonstrating combined visual markup and textual feedback input.

FIG. 3 is a screenshot showing the just-in-time user interface menu of the system that responds to user click, displaying contextual editing tools including selection, fill, mirror, transform, layer, focus, and deletion operations, with a selection bounding box around the tram object. When used in conjunction with the annotation shown in FIG. 2B, FIG. 3 illustrates how the system captures both visual annotations and subsequent editing operations as part of the comprehensive edit history.

FIG. 4 is a screenshot showing an example of an edit action, specifically an easy object magnification edit action which has segmented, delayered, and filled the background, with the tram object selected and enlarged using genAI.

FIG. 5 is the final image output after all transformations have been applied, showing the enhanced composition with blurred background and emphasized tram subject.

FIG. 6 is a screenshot showing the final image along with the “Action to Intent” workflow in action, displaying a generated intent statement that reads “To emphasize the tram, I would pull it ahead and defocus the far background,” along with user attribution and options for translation.

FIG. 7 is a system architecture block diagram showing the complete “Action to Intent” pipeline, including: the collaborative design canvas for expert and non-expert users, database for uploads, parallel paths for visual feature extraction and expert annotations, enriched embeddings with appended visual attributes and skill detection, feature correction interface for refining and personalizing embeddings, vector storage with embeddings and similarity index for building user markup and intent corpora, reasoning arcs and knowledge graphs built from design cycles and feedback, visual retrieval measuring distance between visual features within user-specific corpora, multimodal large language model call with few-shot examples and system prompts describing action and design intent, intent extraction and explanation generation enriched with related design examples or video snippets, and the final display interface showing stored action-to-intent mappings that refine the knowledge graph.

FIGS. 8A-8C are a sequence of user interface screenshots showing the feature correction interface for perspective detection: FIG. 8A shows the interface with detected visual features displayed as clickable tags (“x perspective” and “x color harmony”) above the text input field; FIG. 8B shows the perspective grid overlay displayed on the image after the user clicks the perspective tag, with automatically detected vanishing points and converging lines generated by a pretrained perspective detection model; FIG. 8C shows the user correcting the placement of the perspective grid by dragging the vanishing point to a new location, demonstrating the user-correctable feature detection that builds personalized visual vocabularies.

FIGS. 9A-9B are user interface screenshots showing the just-in-time slider interface for continuous parameter adjustment: FIG. 9A shows the interface with expert textual feedback displayed above an image, a saturation slider control with an automated enhancement tool, and the image at a first saturation level; FIG. 9B shows the same interface with the slider moved to a second position, displaying the image with adjusted saturation, demonstrating how the system surfaces contextual controls in response to expert feedback and logs continuous parameter changes in the comprehensive edit history.

FIG. 10 is a conceptual diagram showing the mapping between design elements and design principles. The left column lists Principles of Design (Balance, Gradation, Repetition, Contrast, Harmony, Dominance, Unity) that humans react to when viewing visual designs. The center column lists Elements of Design (Line, Shape, Direction, Proportion, Texture, Color, Value, and Planes of interest) that users directly manipulate through edits. The right side shows two feedback examples demonstrating how the system learns element-to-principle mappings: Example 1 shows text-based feedback where visual feature detection ties element-level changes to principles; Example 2 shows visual edit feedback (corresponding to the annotation style shown in FIG. 2B) where the system learns that scaling an object ties the element of proportion to the intent of achieving dominance.

FIG. 11 is a screenshot of the designer-customer workflow interface showing a complete design cycle from creative brief through multiple feedback iterations to final validation. The interface displays: an initial creative brief, reference materials, multiple design iterations with corresponding customer feedback, a visual timeline showing progression through design and feedback stages, and system-generated validation statements about the changes. This figure demonstrates how the system captures entire reasoning arcs from design intent through execution to output, as exemplified by the input modalities shown in FIGS. 2A-2B and editing operations shown in FIG. 3.

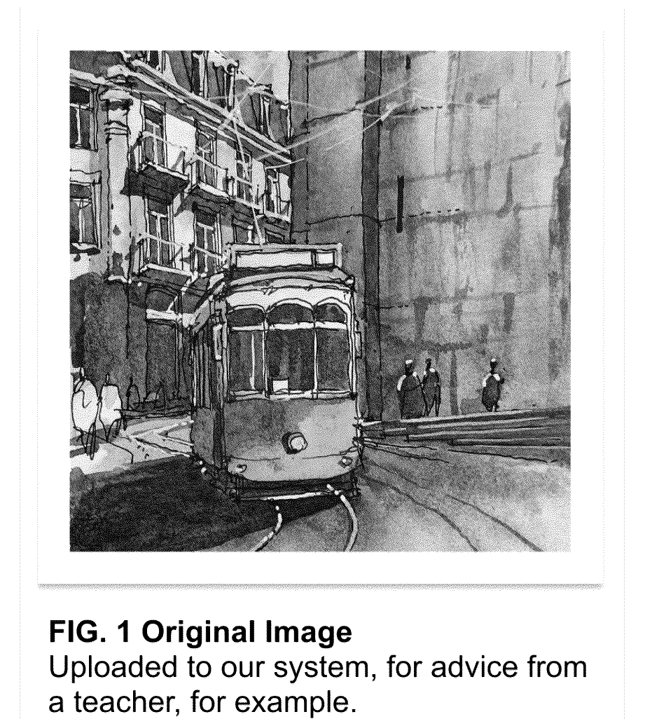

### DETAILED DESCRIPTION OF THE INVENTION

### Overview of System Architecture

The “Action to Intent” system is composed of the following key components:

Visual Feature Extraction Module: Analyzes edited digital assets using computer vision techniques to automatically extract visual feature vectors. The extracted features characterize design elements including line quality (stroke weight, consistency, expressiveness), shape composition (geometric relationships, proportions, arrangements), color properties (hue, saturation, value), color harmony (complementary, analogous, triadic relationships), color distribution (spatial arrangement of colors), edge width variation, gradients (smooth transitions between values or colors), composition of shapes in size and values, distribution of values (the pattern of light and dark areas), perspective (depth cues, vanishing points), depth separation (foreground/background relationships), and distortion effects. These features correspond to the fundamental elements of design: line, shape, color, size, direction, texture, and value.

Feature Correction Interface: After automatic extraction, the system presents detected features to the user through an interface that allows review and correction. When a user corrects feature detection, the system records both the original detection and the user's correction, building a personalized feature interpretation model. This creates a “personalized recipe” that captures what specific visual features mean to that individual user, enabling the system to learn user-specific visual vocabulary over time.

Multimodal Encoding Module: Generates joint representations that combine extracted visual feature vectors with textual annotations, user-drawn marks on the image, textual comments, and edit metadata. The encoding process creates vector embeddings that preserve both visual semantics (which cannot be fully expressed in text) and textual context. These embeddings enable similarity-based retrieval that considers the full multimodal context of each edit.

Graph Database and Vector Store: Stores the comprehensive edit history, visual features, user profiles, intent statements, and their interrelationships. The graph structure captures three primary relationship types: relationships between edits made by the same user (temporal sequences, stylistic connections), relationships between users and their characteristic visual features (personal style patterns), and relationships between visual features and generated intent statements (feature-to-principle mappings). The vector embedding store enables efficient similarity search for retrieval of contextually relevant examples.

Input Tracking Module: Captures edits or changes made by the user across various domains (e.g., image, text, code). It records both the original and final states of the content, enabling detailed action history logging. Each edit is linked to its extracted visual features and joint multimodal representation.

Context Extraction Module: Extracts relevant context for each edit, including domain-specific guidelines, user roles, design objectives, and patterns from past actions. This module ensures that edits are interpreted within their proper situational and stylistic context.

Retrieval Module: Performs similarity search on the vector embedding store to dynamically select user-specific examples based on contextual relevance to a current edit. The retrieval considers both visual similarity (based on extracted features) and semantic similarity (based on joint multimodal embeddings). This enables high-quality retrieval from a relatively small user-specific corpus without requiring large-scale generic training data.

Machine Learning and NLP Engine: Analyzes the recorded edits, their context, the extracted visual features, and the retrieved few-shot examples to dynamically infer intent categories. Rather than relying on predefined intent labels, the system learns personalized intents over time by identifying recurring patterns and rationales from the user's history and feedback pairs. The engine maps from design elements (what the user changed) to design principles (what the user intended to achieve).

Explanation Generation Module: Transforms the inferred rationale into a clear, plain-language “intent statement” tailored to the user's style and editing history. This module specifically addresses the challenge of translating visual intent into textual form, bridging communication between visually-oriented creators and non-visually-oriented audiences. The output aligns with the user's unique workflow, preferences, and personalized visual vocabulary established through feature correction.

Feedback Storage Module: Associates generated intent statements with their corresponding edits, visual features, and joint multimodal representations. These associations are stored in the graph database and made available to the retrieval module for future similarity searches, creating a self-improving feedback loop.

UI Integration Layer: Presents the generated intent statements seamlessly in the user interface, making them accessible in revision histories, tooltips, or workflow summaries.

### Design Elements and Design Principles

A key insight underlying the present invention is the distinction between design elements and design principles. Users can only directly manipulate design elements: line (the path of a point moving through space), shape (enclosed areas defined by lines or color), color (hue, saturation, and value properties), size (the relative dimensions of elements), direction (the visual flow or movement), texture (the surface quality, actual or implied), value (the lightness or darkness of tones), and focal planes and areas of interest.

However, users are typically reacting to and attempting to achieve design principles: gradation (gradual change in elements), repetition (recurring elements creating pattern and rhythm), contrast (juxtaposition of different elements), harmony (pleasing arrangement of elements), dominance (emphasis on certain elements over others), unity (coherent wholeness of the composition), and balance (visual equilibrium in the composition).

The visual feature extraction module is specifically designed to capture the design elements that users manipulate. The intent extraction process then maps these element-level changes to principle-level intentions. For example, when a user increases the saturation of a foreground object while desaturating the background, the system recognizes this as manipulation of the color element in service of the dominance and contrast principles, and generates an intent statement such as “Adjusted color saturation to create visual dominance of the foreground subject through increased contrast with the background.”

### Visual Feature Vector Extraction

The visual feature extraction process employs computer vision analysis of pixel-level properties and spatial relationships within the edited digital asset. For each edit, the system analyzes the before and after states to identify which visual features changed and how they changed.

The specific visual features extracted include color harmony analysis, edge analysis, and perspective detection. For color harmony, the system extracts dominant colors and stores the ratio of the top 3, top 5, and top 9 dominant colors in the image. Before extracting dominant colors, the system may optionally apply blur to remove noise artifacts that could affect color detection accuracy. The extracted color ratios are tied to standard color wheel relationships such as complementary, analogous, and triadic schemes. Importantly, the system weighs textual feedback from users related to the image more heavily than automated model labeling, allowing the system to understand color harmonies in a culturally-informed way that reflects individual user interpretation.

For edge analysis, the system uses a vision or video model to extract edges from the image and categorizes edge widths into ratio categories of fine, medium, and thick. This categorization captures the line quality element of design and supports intent inference related to detail level, emphasis, and stylistic choices.

For perspective detection, the system uses an in-house or outsourced perspective model, depending on quality of operation at the time of production, to detect edges and horizon lines. The system stores detected edges, the automatically detected horizon line, and any user-corrected horizon line. Certain attributes like perspective are conditionally extracted and saved only when the system detects the image to be a landscape or urban view, reducing unnecessary computation and storage for images where perspective analysis is not relevant.

These features are selected based on domain expertise in visual design and experimentation to identify features that effectively capture design intent. The feature set enables the system to distinguish between edits made for different purposes—for example, distinguishing a crop made for compositional balance from a crop made to remove unwanted elements.

### User-Correctable Feature Detection and Personalization

After automatic feature extraction, the system presents the detected features to the user through a review interface. The user may accept, modify, or reject the detected features. When a user provides corrections, the system records: the original automatically detected feature values, the user's corrected values, the context of the correction (what edit was being made), and the timestamp and user identifier.

Over time, these corrections build a personalized feature interpretation model for each user. The system learns, for example, that a particular user considers certain color combinations to be “harmonious” even if they don't match standard color theory definitions, or that a user has a personal threshold for what constitutes “high contrast.” This personalized visual vocabulary ensures that retrieved examples and generated intent statements reflect the user's individual understanding and preferences.

### Multiple Input Modalities for Edit Capture

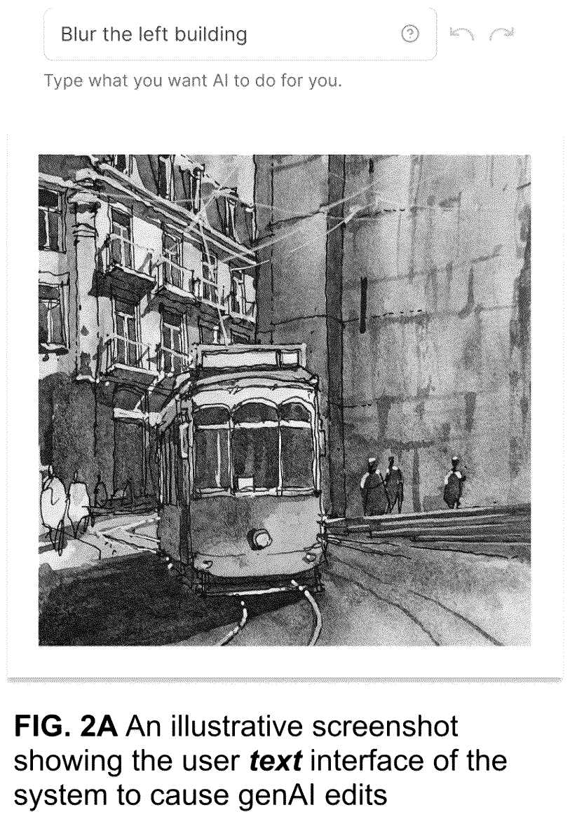

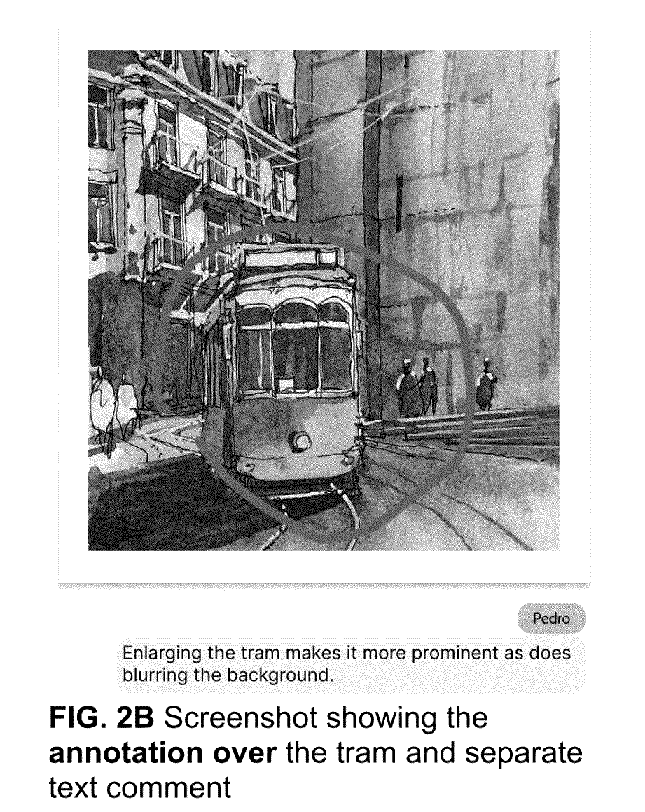

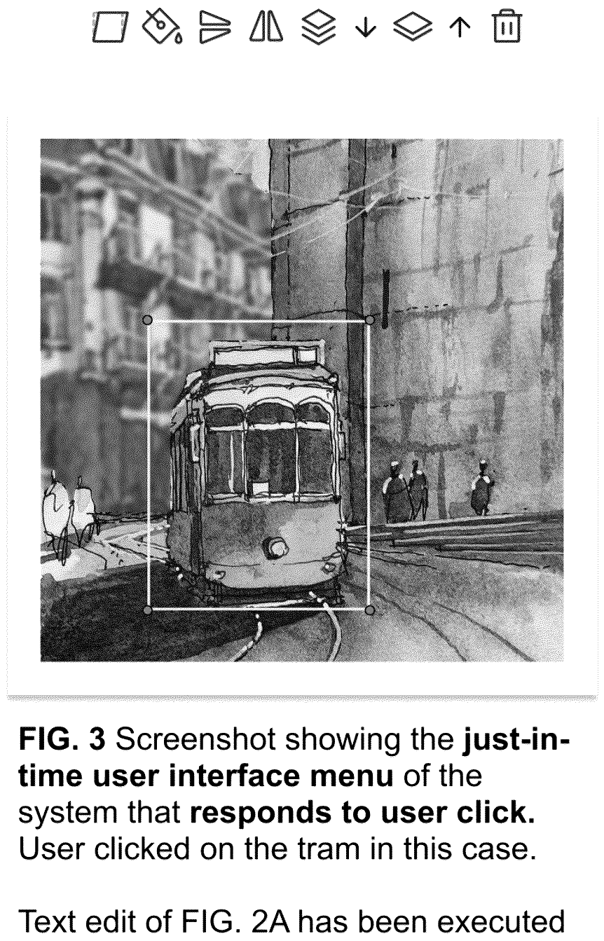

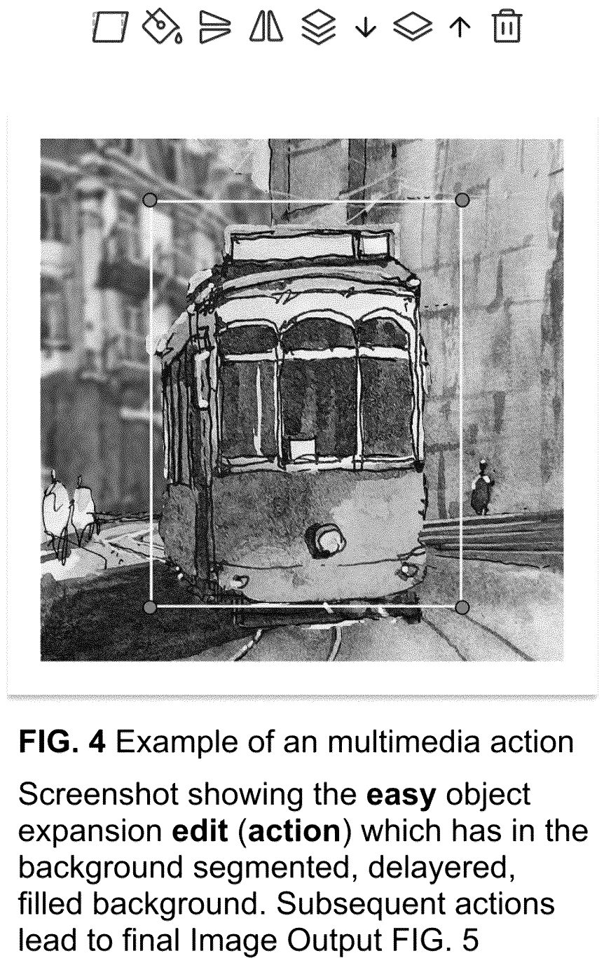

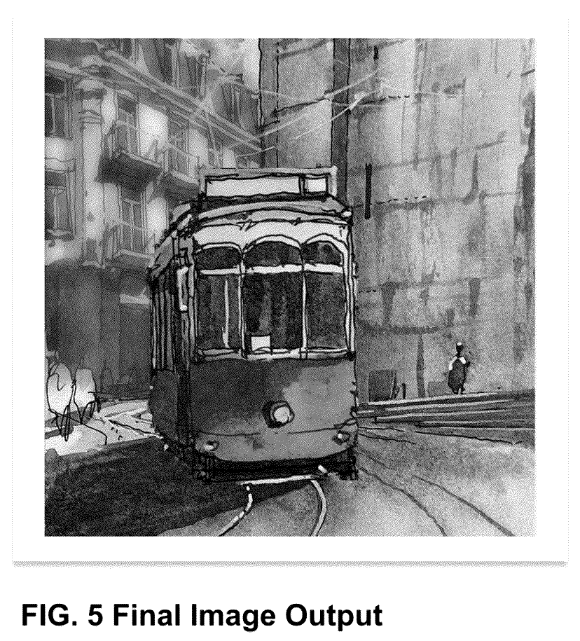

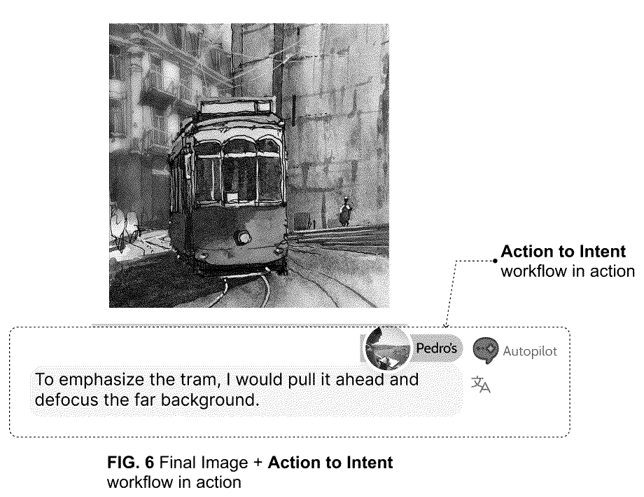

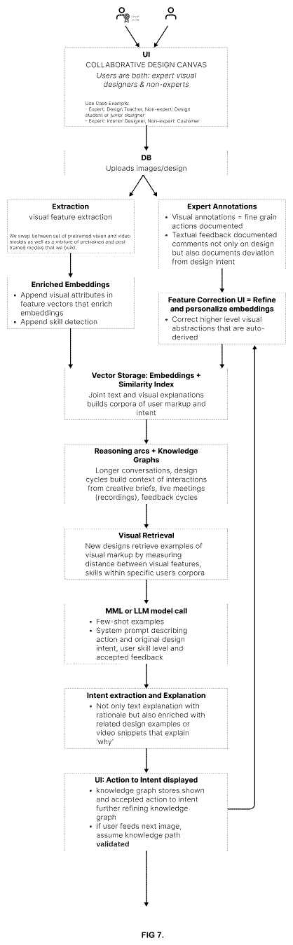

The system supports multiple input modalities for capturing user edits and feedback. In one embodiment illustrated in FIG. 2A, users provide text-based commands through a text input interface, such as “Blur the left building,” which the system interprets and executes as generative AI operations. In another embodiment illustrated in FIG. 2B, users provide visual annotations directly on the digital asset, such as drawing a circled region to indicate an area of focus, combined with textual comments explaining the annotation. The system captures both the visual markup (including the geometric properties of drawn shapes, their position relative to image features, and their spatial extent) and the associated textual commentary as part of the joint multimodal representation. This dual-modality input enables the system to learn from both explicit textual instructions and implicit visual gestures, enriching the personalized vocabulary for each user.

### Model-Agnostic Visual Feature Detection

The system employs a model-agnostic approach to visual feature detection, wherein the specific machine learning models used for feature extraction may be selected, combined, or replaced based on operational quality requirements. In one embodiment, the system uses a pretrained perspective detection model to identify vanishing points, horizon lines, and converging edges in images depicting landscape or urban scenes. In another embodiment, the system uses a combination of pretrained and post-trained (fine-tuned) models optimized for specific visual domains. The system architecture supports swapping between different model implementations, allowing the system to adopt improved models as they become available without requiring changes to the overall pipeline.

### Pre-Populated Feature Overlays and User Correction Interface

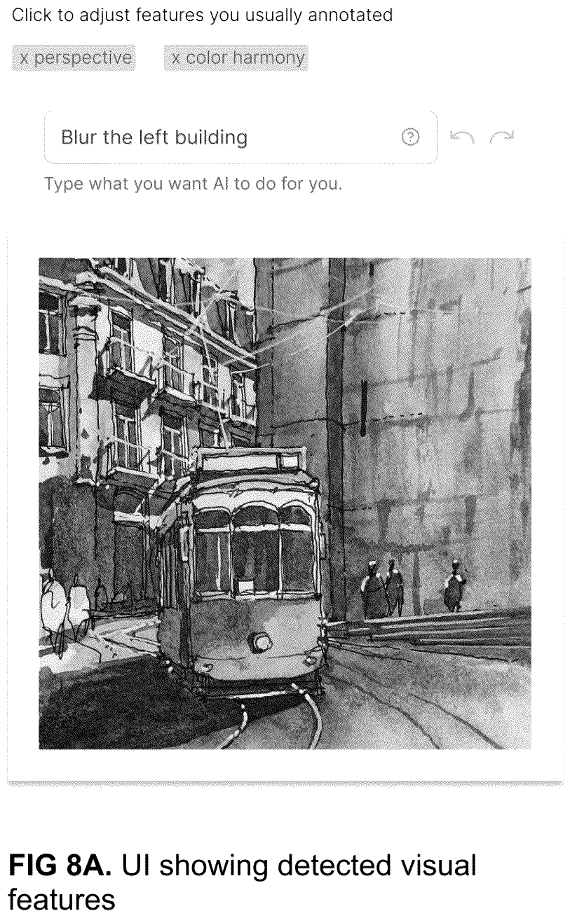

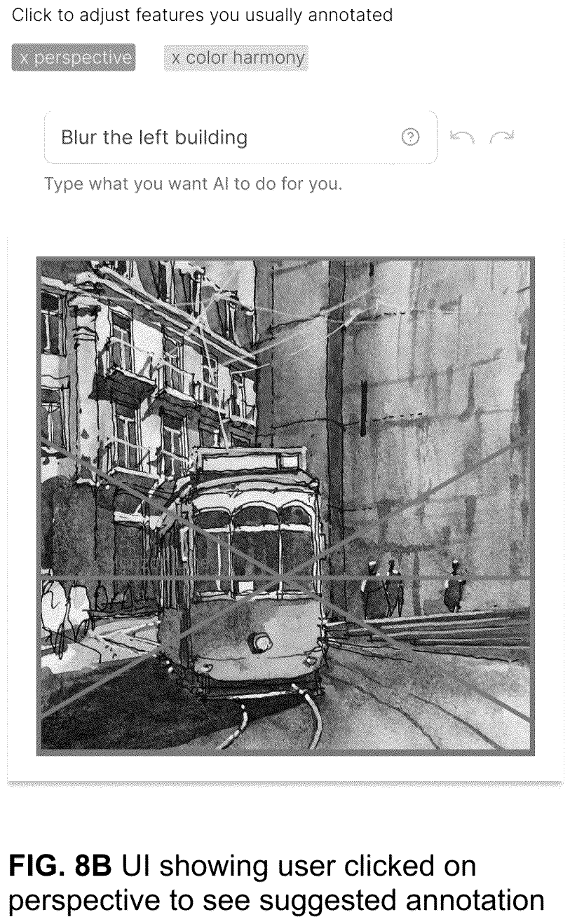

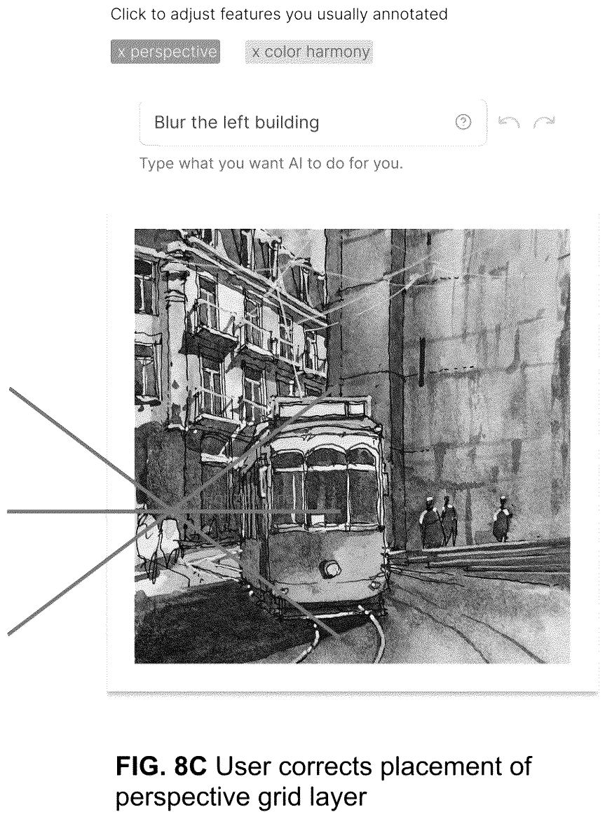

In one embodiment, the feature correction interface presents model-detected visual features as interactive overlays on the digital asset, reducing user effort compared to manual annotation from scratch. As illustrated in FIGS. 8A-8C, for perspective detection the system displays a perspective grid generated by a pretrained perspective detection model, showing detected vanishing points, horizon lines, and converging edges. The user may accept the detected perspective by proceeding without modification, adjust the grid by dragging control points to new positions, or reject the detection entirely by dismissing the overlay. Each of these user actions is recorded in the comprehensive edit history and contributes to building the user's personalized visual vocabulary.

### Contextual Just-in-Time Interface Controls

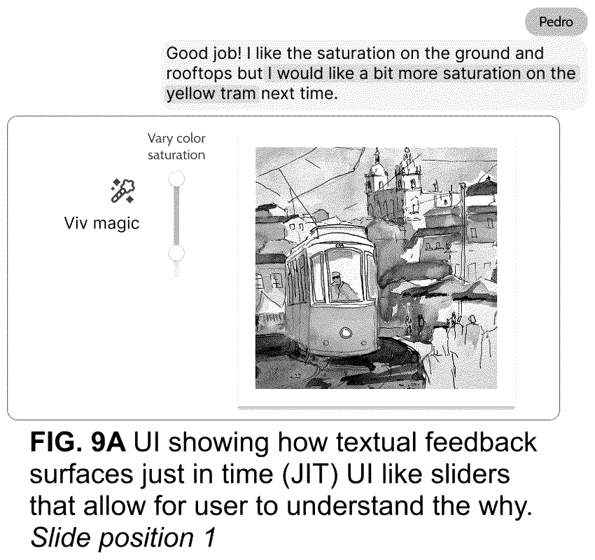

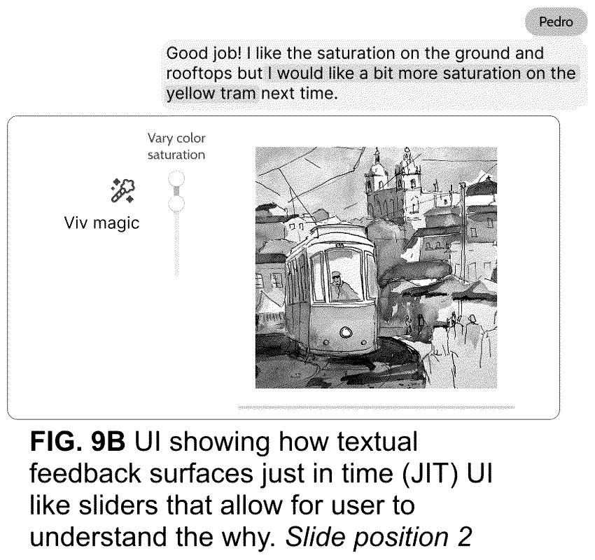

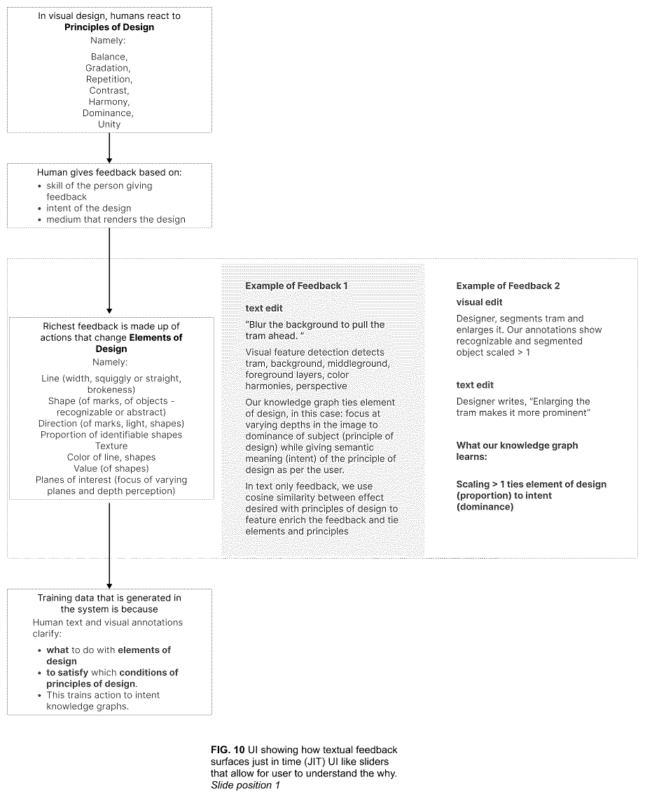

In another embodiment, the user interface includes contextual controls that appear in response to expert feedback or user actions, providing just-in-time access to relevant editing operations. As illustrated in FIGS. 9A-9B, when expert feedback mentions a specific visual attribute, the system surfaces a slider control for that attribute enabling fine-grained continuous parameter adjustment. Each slider position is logged as an edit action with associated parameter values, enabling the system to capture continuous parameter changes and providing richer data for intent inference.

### Graph Database Structure

In one embodiment, the graph database stores relationships between system entities using a graph structure that may be expressed as: (User)-[: MEMBER_OF]->(Workspace), (User)-[: SUBMITTED]->(Design), (Design)-[: HAS_VERSION]->(Version), (Version)-[: NEXT_VERSION]->(Version) forming revision chains, (Design)-[: HAS_FEATURE]->(Feature), (Feature)-[: CORRECTED_BY]->(User) capturing personalization, (User)-[: ANNOTATED]->(Annotation), (Annotation)-[: ON]->(Design), (Version)-[: HAS_EMBEDDING]->(Embedding), and (Embedding)-[: PRODUCES]->(IntentStatement). This graph structure enables traversal-based queries such as finding all edits by a user involving similar visual features, identifying patterns in feature corrections, and discovering relationships between visual feature combinations and design principles.

### Design Workflow Capture and Reasoning Arcs

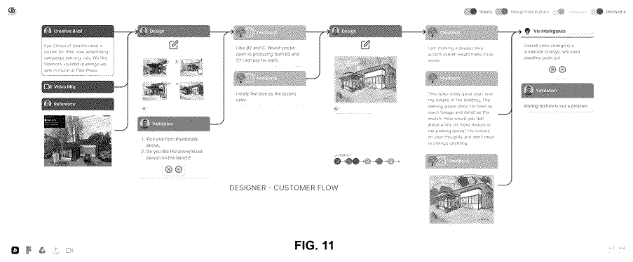

As illustrated in FIG. 11, the system captures entire design workflows comprising multiple iterations of design and feedback. The system stores not only individual edits but also the sequential relationships between edits, the feedback that prompted subsequent changes, and the ultimate validation or acceptance decisions. This comprehensive capture enables the system to build reasoning arcs—semantically meaningful sequences that encode the purpose behind editing workflows. These reasoning arcs support downstream applications including project timeline estimation, identification of recurring patterns in expert-to-novice communication, and discovery of efficient editing strategies.

### Joint Multimodal Representation and Vector Embeddings

The multimodal encoding module generates joint representations that combine multiple data types into unified vector embeddings. The inputs to the encoding process include: extracted visual feature vectors, user annotations on the digital asset (including drawn marks, highlights, and arrows), textual comments or notes provided by the user, edit action parameters (crop coordinates, color adjustment values, etc.), and contextual metadata (timestamp, project context, user role).

User annotations are particularly significant because they often contain implicit information about the user's style and intent. For example, a textual annotation such as “stylize the landscape” provides hints about the user's visual intent that would be difficult to capture through visual feature extraction alone. The joint representation preserves both the visual semantics of the annotation's placement and the textual semantics of its content.

The resulting vector embeddings enable similarity-based retrieval that considers the full multimodal context. Two edits may be retrieved as similar because they share visual features, because they have similar textual annotations, because they were made in similar contexts, or any combination thereof. This multimodal similarity is more effective for intent matching than text-only or image-only similarity.

### Edit Action Data Structure

The system stores comprehensive edit action data in a structured format that captures both standard edits and AI-aided operations. A simplified representation of the image annotation structure includes: geometric transformations (crop boundaries, flip states for horizontal and vertical axes, rotation angle), manipulation records (each with a unique identifier, position coordinates, dimensions, rotation, background properties, selection style, and associated AI operations), AI operation records (including prompts provided by the user, result references, and selection regions that define the area of operation), and decoration, annotation, and selection layers. This structure enables the system to maintain complete provenance of all edits, including the relationship between user intent expressed through prompts and the resulting visual changes.

### Graph Database Structure and Relationships

The graph database stores nodes representing multiple entity types. User nodes contain user identifier, role, workspace memberships, and cohort memberships. Workspace nodes contain member identifiers, workspace rules, workspace intent, start and end dates, and the latest workflow stage. Design nodes contain design identifier, creation timestamp, media type (image, video, text, or AI-generated), revision number, associated annotation identifier, annotator identifier, parent design identifier for version chains, and root message identifier. Annotation nodes contain annotation identifier, text annotation content, and image annotation data structures. Embedding nodes contain embedding identifier, model used, dimensionality, and a reference pointer to the vector store. Agent Response nodes contain response identifier, agent type (RAG or reasoning), text content, and confidence score.

Edges in the graph capture relationships including: User to Workspace membership, User to Design creation, Design to Annotation association, Design to Design parent-child relationships forming revision chains, Annotation to Embedding linkage, and Embedding to Agent Response generation. This graph structure enables sophisticated queries such as finding all edits by a user that involved similar visual features, identifying patterns in how a user's feature corrections differ from automatic detection, traversing from a current edit to historically similar edits and their associated intent statements, and discovering relationships between specific visual feature combinations and specific design principles.

### Similarity-Based Retrieval Process

When a user makes a new edit, the retrieval module performs similarity search to find relevant examples from the user's history. The process involves: encoding the current edit as a joint multimodal vector embedding, querying the vector store for embeddings with high cosine similarity, filtering results to include only edits from the same user (or optionally from users with similar profiles), ranking results by relevance considering both vector similarity and graph relationships, and selecting the top-k results as few-shot examples for the language model.

The enriched vector embeddings, which incorporate domain-specific visual features optimized for capturing design intent, enable high-quality retrieval from relatively small user-specific corpora. This is a significant advantage over generic retrieval systems that require large-scale training data to achieve acceptable performance.

### Multimodal Language Model Processing

The multimodal large language model receives a prompt comprising: the current edit with its before and after states, the extracted visual features and joint multimodal representation, the retrieved few-shot examples (each including an edit, its features, and its previously generated intent statement), the user's personalized feature interpretations (if corrections have been recorded), and contextual information about the project and user role.

The multimodal capability is essential, not optional. The model must process both the visual information (images, feature vectors) and textual information (annotations, metadata, few-shot examples) together to generate accurate intent statements. A text-only model would be insufficient because visual editing actions contain information that cannot be fully expressed in textual form—the precise quality of a color adjustment, the exact nature of a compositional change, or the subtle relationship between edited elements.

The model applies multiple reasoning approaches: pattern matching against few-shot examples to identify similar past situations, rule-based heuristics (e.g., if value contrast increased significantly, the intent may relate to emphasis or dominance), semantic analysis of the relationship between changed elements and design principles, and synthesis of the user's historical patterns into a coherent understanding of their intent.

### Visual-to-Text Translation for Non-expert Audiences

A primary purpose of the system is to bridge communication between visually-oriented users (designers, artists, visual educators) and non-visually-oriented audiences (clients, customers, students without visual training). The generated intent statements translate visual editing decisions—which the creator understands intuitively but may struggle to articulate—into clear textual explanations that non-experts can understand.

This translation addresses a fundamental inefficiency in creative workflows: visual thinkers are forced to use text-based tools to explain their work, even though text is a lossy medium for conveying visual intent. Writing textual explanations is exhausting for visual thinkers and often fails to capture the full meaning of their decisions. By automating this translation, the system reduces the communication burden on visual professionals while improving the quality and consistency of explanations provided to non-expert audiences.

### Intent Statement Generation

Once the system identifies the probable rationale, it generates a concise explanatory statement. The statement may include: (1) Action: summarizing what was done at the element level (e.g., “Increased color saturation in the foreground”); (2) Rationale: why it was done at the principle level (e.g., “to create visual dominance and draw attention to the subject”); and (3) Beneficial outcome (optional): the expected effect on the viewer or the design (e.g., “ensuring the viewer's eye is guided to the focal point”).

Example intent statements include: “Removed unnecessary background details and reduced background saturation to create contrast and emphasize the primary figure, achieving visual dominance that guides the viewer's gaze to the subject.” and “Adjusted the crop to position the main subject along the rule-of-thirds intersection, improving compositional balance and creating a more dynamic visual flow.” These intent statements are tailored to the user's style based on their historical patterns and personalized visual vocabulary.

### Feedback Loop and Continuous Learning

The system implements a feedback loop that enables continuous improvement. When an intent statement is generated, it is stored in association with the corresponding edit, visual features, and joint multimodal representation. This association is added to the graph database and the vector store, making it available for future retrieval.

The feedback loop operates automatically without requiring explicit user input. Each generated intent statement becomes a potential few-shot example for future edits. Over time, this builds a growing library of action-to-intent pairs that enables progressively more accurate intent statement generation. The system effectively learns from its own outputs, with the quality of retrieval and generation improving as the user's edit history accumulates.

Optionally, the system may allow users to provide explicit feedback on generated intent statements (confirming, correcting, or rejecting them). This explicit feedback, when provided, is weighted more heavily in future retrieval and further accelerates the learning process.

### System Ownership and Control Requirements

A critical aspect of the invention is that the system maintains ownership and control over the comprehensive edit history, visual features, vector embeddings, and graph relationships. This ownership is a prerequisite for generating accurate, personalized intent statements. Without access to the complete edit history and its associated multimodal representations, the system cannot perform effective similarity-based retrieval or build the personalized models that enable accurate intent inference.

The system's control over the edit history ensures that all relevant data is available to the multimodal large language model. Partial or fragmented histories would result in degraded retrieval quality and less accurate intent statements. The system architecture is designed to maintain sole custody of this data, with the retrieval module accessing user-specific examples only through the controlled history-tracking infrastructure.

### User Interface/Editor Integration

The UI Integration Layer ensures seamless interaction with the system through multiple touchpoints. Real-Time Feedback provides users with a brief pop-up or sidebar showing the generated intent statement upon completing an edit. Review/History Mode allows users to view revision histories, including side-by-side comparisons and corresponding AI-generated explanations. Peer Collaboration features highlight edits in collaborative environments, color-coding them with corresponding intent statements appended to each revision. This transparency ensures that all stakeholders—reviewers, students, collaborators, clients—can understand the why behind every change, not just the what.

### Example Use Cases

Client Communication: A graphic designer adjusts a logo design for a client. Rather than writing a lengthy email explaining the changes, the system generates: “Increased the weight of the primary letterforms while reducing secondary element sizes, creating clearer visual hierarchy and improving legibility at small sizes. Adjusted color saturation to align with brand guidelines while maintaining sufficient contrast for accessibility.” The designer can share this explanation directly with the client, saving time while providing professional-quality communication.

Art/Design Critiques: A mentor in a digital painting course adjusts the color saturation and adds blur to background elements in a student's work. The system generates: “Reduced background saturation and added depth blur to create contrast between foreground and background, establishing visual dominance of the primary subject and guiding the viewer's attention. This technique creates atmospheric perspective that enhances the sense of depth in the composition.” The student receives not just the edit but an educational explanation of the design principles being applied.

Project Estimation: The system analyzes accumulated reasoning arcs—the complete sequences of edits from design intent through execution to final output—along with recorded time durations for each edit. When a new user provides a design brief, the system matches the brief to historical reasoning arcs from similar projects and generates a projected timeline and cost estimate. The projection assumes average user efficiency when user-specific historical data is unavailable, providing realistic expectations before work begins.

Product Photography Review: An e-commerce company's design team reviews product images. When a senior designer adjusts lighting, removes background distractions, and enhances product colors, the system generates: “Balanced lighting to eliminate harsh shadows while maintaining dimensional cues. Removed competing visual elements from background to ensure product dominance. Enhanced color vibrancy within brand-acceptable range to increase visual appeal while maintaining accurate product representation.” Junior team members learn the reasoning behind quality standards.

### Variations and Alternate Embodiments

Domain-Agnostic: While examples emphasize visual design, the system can be applied to any domain where edits occur and intent communication is valuable—e.g., video editing, audio production, 3D modeling applications, UI/UX design tools, etc. The visual feature extraction module can be configured with domain-specific features appropriate to each application.

Offline vs. Cloud Implementation: The AI modules could run locally on a user's machine or be hosted as cloud services. The graph database and vector store may be local, cloud-hosted, or hybrid depending on privacy requirements and performance needs.

Integration with Collaboration Platforms: The system could be extended to Slack, Microsoft Teams, or project management tools, offering inline “intent” annotations. Design tools such as Figma, Adobe Creative Suite, or Canva could integrate the system to provide automatic intent explanations for design changes.

User Customization: Users can define personal or organizational guidelines to shape how the AI interprets and labels edits. For instance, an organization might have a custom style guide or brand guide that influences how design principles are interpreted and explained.

This flexibility ensures the system can be tailored to unique workflows and environments without losing its core functionality.

What is claimed is:

1. A computer-implemented method for generating user-specific intent statements for visual digital asset edits, the method comprising:
extracting, by a processor, a plurality of visual feature vectors from an edited visual digital asset by analyzing pixel-level differences between a pre-edit version and a post-edit version of the visual digital asset, wherein the visual feature vectors characterize design elements including at least two of: line quality, shape composition, color harmony, color distribution, edge width variation, gradients, value distribution, perspective, or depth separation;
generating, by the processor, a joint multimodal representation comprising the extracted visual feature vectors and associated textual metadata, wherein the joint multimodal representation is stored as vector embeddings in a database;
recording, by the processor, each edit made to the visual digital asset in a structured data log, wherein the structured data log is linked to the joint multimodal representation;
maintaining, by the processor, a comprehensive edit history comprising all past edits and their associated joint multimodal representations for a user;
dynamically selecting, by the processor, user-specific few-shot examples from the comprehensive edit history by performing similarity retrieval on the vector embeddings based on contextual relevance to a current edit;
transmitting, by the processor, the current edit, the joint multimodal representation, and the dynamically selected few-shot examples to a multimodal large language model; and
generating, by the multimodal large language model, a personalized textual intent statement that explains the rationale behind the current edit, wherein the textual intent statement translates visual editing actions into natural language reflecting the user's editing style and patterns derived from the few-shot examples.

2. The method of claim 1, wherein the visual feature vectors are extracted using computer vision analysis of pixel-level properties and spatial relationships within the edited digital asset.

3. The method of claim 1, further comprising:
presenting the extracted visual feature vectors to the user through an interface;
receiving user corrections to the extracted visual feature vectors; and
recording the user corrections to build a personalized visual vocabulary that captures what specific visual features mean to the user.

4. The method of claim 3, wherein the personalized visual vocabulary is used in subsequent similarity retrieval to match the user's individual interpretation of visual features rather than standard definitions.

5. The method of claim 1, wherein extracting visual feature vectors for color harmony comprises:
extracting dominant colors from the digital asset;
storing ratios of the top 3, top 5, and top 9 dominant colors;
optionally applying blur to remove noise artifacts before extracting dominant colors; and
associating the color ratios with standard color wheel relationships while weighing user textual feedback more heavily than automated model labeling.

6. The method of claim 1, wherein extracting visual feature vectors for edge analysis comprises using a vision or video model to extract edges and categorizing edge widths into ratio categories of fine, medium, and thick.

7. The method of claim 1, wherein extracting visual feature vectors for perspective comprises detecting edges and horizon lines, storing both automatically detected horizon lines and user-corrected horizon lines, and conditionally extracting perspective attributes only when the digital asset is detected to be a landscape or urban view.

8. The method of claim 1, wherein the joint multimodal representation further comprises visual annotations made by the user on the digital asset, the visual annotations including at least one of: drawn marks, highlights, arrows, or textual comments placed on the digital asset.

9. The method of claim 1, wherein the database comprises a graph database configured to store relationships between edits, users, and visual features, enabling traversal-based retrieval of contextually related examples.

10. The method of claim 1, wherein the visual feature vectors characterize design elements that users directly manipulate, and wherein the personalized textual intent statement maps the design elements to design principles including at least one of: gradation, repetition, contrast, harmony, dominance, unity, or balance.

11. The method of claim 1, wherein the similarity retrieval on vector embeddings enables high-quality retrieval of relevant examples from a corpus of limited size specific to the user, without requiring large-scale training data.

12. The method of claim 1, wherein the personalized textual intent statement bridges communication between a visually-oriented user who created the edit and a non-visually-oriented recipient who receives the explanation.

13. The method of claim 1, wherein the multimodal large language model is required to process both the visual feature vectors and the textual metadata to generate the personalized textual intent statement, and wherein a text-only model would be insufficient to interpret the visual editing actions.

14. The method of claim 1, further comprising:
storing the generated personalized textual intent statement in association with the current edit and its joint multimodal representation in the comprehensive edit history; and
using the stored intent statement as a few-shot example for generating intent statements for subsequent edits by the same user.

15. The method of claim 14, wherein the system builds, over time, a growing library of action-to-intent pairs comprising edits, their joint multimodal representations, and their associated intent statements, wherein the library enables progressively more accurate intent statement generation as the user's edit history accumulates.

16. The method of claim 15, further comprising:
analyzing the accumulated library of action-to-intent pairs to identify reasoning arcs comprising sequences of edits from design intent through execution to output;
recording time duration data associated with each edit in the reasoning arcs;
receiving a new design brief from a user; and
generating a projected timeline and cost estimate for the new design brief based on similarity matching to historical reasoning arcs and their associated time duration data, wherein the projection assumes average user efficiency when user-specific historical data is unavailable.

17. The method of claim 1, wherein the system maintains exclusive ownership and control over the comprehensive edit history such that all relevant edit data, visual feature vectors, and joint multimodal representations are available to the multimodal large language model for generating the personalized intent statement.

18. The method of claim 1, wherein generating an accurate personalized intent statement requires access to the comprehensive edit history maintained by the system, and wherein the system's control over the edit history is a prerequisite for intent statement generation.

19. A system for translating visual editing actions into personalized textual intent explanations, the system comprising:
a non-transitory computer-readable storage medium comprising a graph database and a vector embedding store;
a visual feature extraction module configured to analyze edited visual digital assets and extract visual feature vectors characterizing design elements including at least two of: line quality, shape composition, color harmony, color distribution, edge width variation, gradients, value distribution, perspective, or depth separation;
a feature correction interface configured to present detected visual features to a user and receive user corrections, thereby building a personalized visual vocabulary for the user;
a multimodal encoding module configured to generate joint representations combining the extracted visual feature vectors with textual annotations, user-drawn marks on the digital asset, and edit metadata;
a history-tracking module configured to log all modifications to digital assets, their associated parameters, and their joint multimodal representations in the storage medium;
a retrieval module configured to perform similarity search on the vector embedding store to dynamically select user-specific examples based on contextual relevance;
a multimodal large language model configured to receive the current edit, its joint multimodal representation, and the selected user-specific examples, and to generate a textual rationale for each edit; and
a display interface configured to present user-specific textual intent statements to users, thereby translating visual editing decisions into natural language explanations for non-visually-oriented audiences.

20. The system of claim 19, wherein the graph database is configured to store nodes representing users, workspaces, designs, annotations, embeddings, and agent responses, and edges representing relationships including user-to-workspace membership, user-to-design creation, design-to-annotation association, design-to-design revision chains, annotation-to-embedding linkage, and embedding-to-agent-response generation.

21. The system of claim 19, wherein the multimodal large language model is configured to map design elements changed by the user to design principles intended by the user, wherein design elements include line, shape, color, size, direction, texture, and value, and wherein design principles include gradation, repetition, contrast, harmony, dominance, unity, and balance.

22. The system of claim 19, further comprising a feedback storage module configured to associate generated intent statements with their corresponding edits and to make the associations available to the retrieval module for future similarity searches, thereby creating a self-improving feedback loop.

23. The system of claim 19, wherein the history-tracking module maintains sole custody of the comprehensive edit history, and wherein the retrieval module can only access user-specific examples through the history-tracking module.

24. The system of claim 19, wherein the system operates across multiple content domains comprising at least two of: image editing, video editing, audio editing, UI/UX design, or product photography.

25. A non-transitory computer-readable medium containing instructions that, when executed by a processor, cause the processor to perform operations comprising:
receiving an edit to a digital asset and extracting visual feature vectors from the edited digital asset, wherein the visual feature vectors encode design elements of the edit;
presenting the extracted visual feature vectors to a user and receiving user corrections to build a personalized visual vocabulary;
generating a joint multimodal representation combining the visual feature vectors with textual metadata and user annotations associated with the edit;
storing the joint multimodal representation as vector embeddings in a graph database in association with a user profile, wherein the graph database stores relationships between edits, users, and visual features;
performing similarity-based retrieval on the vector embeddings to identify user-specific examples contextually relevant to a current edit;
invoking a multimodal artificial intelligence model to interpret the current edit in view of the user's style derived from the retrieved user-specific examples and the personalized visual vocabulary; and
outputting a textual statement explaining the purpose behind the edit, wherein the textual statement translates visual editing intent into natural language that maps design elements manipulated by the user to design principles intended by the user.

26. The non-transitory computer-readable medium of claim 25, wherein the design elements comprise at least two of: line, shape, color, size, direction, texture, or value, and wherein the design principles comprise at least one of: gradation, repetition, contrast, harmony, dominance, unity, or balance.

27. The non-transitory computer-readable medium of claim 25, wherein the textual statement bridges communication between a visually-oriented user who created the edit and a non-visually-oriented recipient, reducing information loss compared to user-authored text descriptions.

28. The non-transitory computer-readable medium of claim 25, wherein the operations further comprise storing the generated textual statement in association with the edit and its joint multimodal representation, making the stored association available as a few-shot example for subsequent edits.

29. The non-transitory computer-readable medium of claim 25, wherein ownership and control of a complete edit history including all joint multimodal representations is a prerequisite for generating accurate user-specific intent statements.

30. The non-transitory computer-readable medium of claim 25, wherein the vector embeddings are enriched with domain-specific visual features selected to capture design intent, the enrichment enabling contextually accurate retrieval from a user-specific corpus without requiring large-scale generic training data.

31. The non-transitory computer-readable medium of claim 25, wherein the multimodal artificial intelligence model is required to process visual information that cannot be fully expressed in textual form, and wherein a text-only model would be insufficient to generate accurate intent statements for visual edits.

32. The non-transitory computer-readable medium of claim 25, wherein the personalized visual vocabulary captures the user's individual interpretation of visual features based on accumulated corrections, enabling intent statements that reflect the user's unique understanding rather than standard definitions.
